(19) United States
(12) Patent Application Publication
(10) Pub. No.: US 2013/0184430 A1
(43) Pub. Date: Jul. 18, 2013

(54) ANTI-ELECTROSTATIC POLYESTER COMPOSITION

(71) Applicant: EVEREST TEXTILE CO., LTD, Tainan City (TW)

(72) Inventors: Jen-Hon Liu, Tainan City (TW); Wen-Chia Hsu, Tainan City (TW); Hsin-Hung Lin, Tainan City (TW); Huang-Shan Lin, Tainan City (TW)

(73) Assignee: EVEREST TEXTILE CO., LTD, Tainan City (TW)

(21) Appl. No.: 13/742,427

(22) Filed: Jan. 16, 2013

(30) Foreign Application Priority Data
Jan. 18, 2012 (TW) 101101954

(51) Int. Cl. C08G 63/183

(52) U.S. Cl. CPC C08G 63/183
USPC 528/308.6

(57) ABSTRACT

A polyester composition includes 150 to 250 parts by weight of terephthalic acid and 100 parts by weight of a diol component. The diol component includes ethylene glycol present in an amount ranging from 99.5 wt % to 95 wt % based on the weight of the diol component and a C3-C5 diol present in an amount ranging from 0.05 wt % to 5.0 wt % based on the weight of the diol component.

### CROSS-REFERENCE TO RELATED APPLICATION

This application claims priority of Taiwanese application no. 101101954, filed on Jan. 18, 2012.

### BACKGROUND OF THE INVENTION

1. Field of the Invention

This invention relates to a polyester composition, more particularly to a polyester composition that exhibits anti-electrostatic property achieved by components of a diol component.

2. Description of the Related Art

Polyethylene terephthalate (PET), a kind of thermoplastic resin, is usually produced via esterification reaction between terephthalic acids (TPA) and ethylene glycols. Because of advantages such as high toughness, light weight, air impermeability and high resistance to acids and bases, PET is usually manufactured as fabrics, films, or containers. In these application fields, products made from PET usually come into physical contact with human skins. For example, clothing manufactured from PET fabrics comes into direct contact with human skin, and various PET products of films and containers are likely to be held by user's hands. However, PET is known to have poor anti-electrostatic effect and easily generates static electricity which makes users uncomfortable. Therefore, there is a need in the art to provide an anti-electrostatic polyester material without sacrificing the advantages mentioned above.

### SUMMARY OF THE INVENTION

Therefore, the object of the present invention is to provide a polyester composition having superior anti-electrostatic effect while still maintaining sufficient mechanical strength.

According to this invention, an anti-electrostatic polyester composition includes 150 to 250 parts by weight of terephthalic acid and 100 parts by weight of a diol component. The diol component includes ethylene glycol present in an amount ranging from 95 wt % to 99.5 wt % based on the weight of the diol component and a C₃-C₅ diol present in an amount ranging from 0.05 wt % to 5.0 wt % based on the weight of the diol component.

### DETAILED DESCRIPTION OF THE PREFERRED EMBODIMENTS

This invention provides an anti-electrostatic polyester composition, which includes 150 to 250 parts by weight of terephthalic acid and 100 parts by weight of a diol component. The diol component includes, based on the weight of the diol component, 95 wt % to 99.5 wt % of ethylene glycol and 0.05 wt % to 5.0 wt % of a C₃-C₅ diol. Preferably, the C₃-C₅ diol is propanediol, butanediol, pentanediol, or combinations thereof. In an embodiment of this invention, the C₃-C₅ diol is composed of propanediol, butanediol, and pentanediol, wherein propanediol and butanediol have identical quantities in weight, each of which is twice a quantity of pentanediol. Preferably, propanediol is 1,2-propanediol, butanediol is 1,3-butanediol, and pentanediol is 1,5-pentanediol.

When the percentage of the C₃-C₅ diol is lower than 0.05 wt %, the anti-electrostatic effect is limited. On the other hand, when the percentage of the C₃-C₅ diol is higher than 5.0 wt %, mechanical strength provided by the polyester composition would be adversely affected, which is disadvantageous to the subsequent applications of the polyester composition. Besides, the applicants found that, within 0.05 wt % to 5.0 wt %, a relatively high percentage of the C₃-C₅ diol will result in a lower melting point of polyester grains made from the polyester composition, thereby facilitating subsequent processing.

This invention provides the polyester composition with superior anti-electrostatic effect by altering the ratio of the components of the diol component without sacrificing the mechanical strength.

### EXAMPLES

### Example 1

For producing 1000 parts by weight of polyethylene terephthalate, 864 parts by weight of terephthalic acid (TPA), 417.9 parts by weight of ethylene glycol, 2.1 parts by weight of a C₃-C₅ diol, and a catalyst were added into a reactor, in which the C₃-C₅ diol was present in 5 wt % of the total weight of the ethylene glycol and the C₃-C₅ diol. The C₃-C₅ diol was composed of 0.84 part by weight of 1,2-propanediol, 0.84 part by weight of 1,3-butanediol, and 0.42 part by weight of 1,5-pentanediol. Thereafter, the reactor temperature was raised to 220° C. to 240° C. to perform esterification reaction for 2.5 hours, followed by sucking air out of the reactor to stimulate polymerization reaction for another 2.5 hours so as to obtain polyethylene terephthalate. The polyethylene terephthalate product was discharged from the reactor and processed to form polyester grains. The polyester grains were subjected to melting point measurement and were further processed into a Pre-Oriented Yarn (POY) with specification of 111 Dens/72 Filaments. Measurements of fineness, mechanical strength, and elongation rate of the POY were conducted and results are recorded in Table 2. Also, a garter was made from the POY in order to measure friction electrostatic voltage and surface resistance, and the results are listed in Table 2 as well.

### Examples 2-5

The method to produce polyethylene terephthalate of each of examples 2 to 5 is similar to that of example 1 except for the weights of TPA, ethylene glycol, and the C₃-C₅ diol. The quantities of the components for examples 2 to 5 are shown in Table 1. The physical properties of the polyester grains, the pre-oriented yarn, and the garter of the examples 2 to 5 were measured and the results are shown in Table 2.

### Comparative Example 1

The method to produce comparative example 1 is the same as that of example 1 except that 864 parts by weight of TPA and 420 parts by weight of ethylene glycol were used. The physical properties of the polyester grains, the pre-oriented yarn, and the garter of Comparative example 1 were measured and the results are shown in Table 2.

### Comparative Example 2

The method to produce comparative example 2 is the same as that of example 1 except for the contents of TPA, ethylene glycol, and the C₃-C₅ diol (see Table 1). Weight percentage of the C₃-C₅ diol was 6 wt % based on total amount of the diol component of the polyester composition. Also, physical properties of the polyester grains, the pre-oriented yarn, and the garter of Comparative example 2 were measured and the results are listed in Table 2.

TABLE 1

| | | Dihydroxylic Alcohol (parts by weight) | | | | |
|---|---|---|---|---|---|---|
| | | Ethylene | Mixed diol component | | | |
| | TPA | Glycol | wt % | 1,2- | 1,3- | 1,5- |
| | (pbw) | (pbw) | in DA | propanediol | butanediol | pentanediol |
| Ex. 1 | 864 | 417.9 | 0.5 | 0.84 | 0.84 | 0.42 |
| Ex. 2 | 864 | 417.9 | 1.0 | 1.68 | 1.68 | 8.4 |
| Ex. 3 | 864 | 417.9 | 2.5 | 4.2 | 4.2 | 2.1 |
| Ex. 4 | 864 | 417.9 | 3.5 | 5.88 | 5.88 | 2.94 |
| Ex. 5 | 864 | 417.9 | 5.0 | 8.40 | 8.40 | 4.20 |
| Comp. | 864 | 417.9 | 0.0 | 0.0 | 0.0 | 0.0 |
| Ex. 1 | | | | | | |
| Comp. | 864 | 417.9 | 6.0 | 10.08 | 10.08 | 5.02 |
| Ex. 2 | | | | | | |

TABLE 2

| | | | Garter | | | |
|---|---|---|---|---|---|---|
| | Polyester | | | | Friction | |
| | grain | | | | Electro- | Surface |
| | Melting | POY | | Elongation | Static | Resis- |
| | point | Fineness | Strength | Rate | Voltage | tance |
| | (° C.) | (Den) | (g/Den) | (%) | (V) | (Ω/sp.) |
| Ex. 1 | 257.4 | 120.1 | 2.48 | 131.8 | 1102 | 10¹² |
| Ex. 2 | 257.1 | 119.5 | 2.46 | 128.3 | 983 | 10¹¹ |
| Ex. 3 | 255.6 | 119.8 | 2.41 | 126.8 | 885 | 10¹¹ |
| Ex. 4 | 250.2 | 120.2 | 2.32 | 125.5 | 823 | 10¹¹ |
| Ex. 5 | 247.5 | 119.3 | 2.21 | 124.7 | 794 | 10¹¹ |
| Comp. | 257.6 | 120.7 | 3.11 | 131.2 | 1229 | 10¹² |
| Ex. 1 | | | | | | |
| Comp. | 240.8 | 120.4 | 1.92 | 122.6 | 778 | 10¹¹ |
| Ex. 2 | | | | | | |

As shown in Table 2, addition of the C₃-C₅ diol in the diol component of the polyester composition indeed enhances the anti-electrostatic effect of polyester products and lowers the melting point of the polyester grains. The anti-electrostatic effect and the lowering of the melting point are improved with the increase in the amount of the C₃-C₅ diol. When the amount of the C₃-C₅ diol is higher than 5 wt % based on the total weight of the diol component, although the anti-electrostatic effect of the polyester products becomes better, the mechanical strength of the pre-oriented yarn drops which results in fracturing of the yarn while sewing. Moreover, the reduced melting point facilitates subsequent applications of the polyester composition.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An anti-electrostatic polyester composition, comprising 150 to 250 parts by weight of terephthalic acid and 100 parts by weight of a diol component, said diol component including ethylene glycol present in an amount ranging from 99.5 wt % to 95 wt % based on the weight of said diol component and a C₃-C₅ diol present in an amount ranging from 0.05 wt % to 5.0 wt % based on the weight of said diol component.

2. The anti-electrostatic polyester composition as claimed in claim 1, wherein said C₃-C₅ diol is selected from the group consisting of propanediol, butanediol, pentanediol, and combinations thereof.

3. The anti-electrostatic polyester composition as claimed in claim 2, wherein said C₃-C₅ diol is composed of propanediol, butanediol, and pentanediol, propanediol and butanediol having identical quantities in weight and being twice a quantity of pentanediol.

4. The anti-electrostatic polyester composition as claimed in claim 3, wherein propanediol is 1,2-propanediol, butanediol being 1,3-butanediol, pentanediol being 1,5-pentanediol.
